(19) United States
(12) Patent Application Publication
(10) Pub. No.: US 2026/0194621 A1
(43) Pub. Date: Jul. 9, 2026

(54) NODE SELECTION FOR SENSING ONE OR MORE OBJECTS IN A JOINT COMMUNICATION AND SENSING SYSTEM

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Remco Litjens, Voorschoten (NL); Haibin Zhang, Voorburg (NL); Ljupco Jorguseski, Rijswijk (NL); Ahmad Mouri Sardarabadi, Delft (NL); Sakshi Agarwal, Delft (NL)

(21) Appl. No.: 19/130,895

(22) PCT Filed: Dec. 8, 2023
(86) PCT No.: PCT/EP2023/084838

§ 371 Date: May 16, 2025

(30) Foreign Application Priority Data
Dec. 13, 2022 (EP) 22213222.7

(51) Int. Cl. G01S 7/00; G01S 13/66

(52) U.S. Cl. CPC G01S 7/006; G01S 13/66

(57) ABSTRACT

A system (1) for enabling sensing of one or more objects (9) is configured to obtain sensing requirements for sensing the one or more objects, e.g. information specifying a target area, obtain communication requirements, e.g. with respect to throughput, latency, and/or reliability level, obtain information on each of a collection of nodes (11-12,31-36), e.g. node locations and receiver characteristics, select a set of nodes from the collection of nodes based on the sensing requirements, the communication requirements, and the information on each of the collection of nodes, and instruct one or more nodes of the set of nodes to participate in sensing the one or more objects. At least one node of the set of nodes will transmit wireless signals and at least one node of the set of nodes will receive the wireless signals.

### FIELD OF THE INVENTION

The invention relates to a system for enabling sensing of one or more objects and a node for participating in sensing of one or more objects.

The invention further relates to a method of enabling sensing of one or more objects and a method of participating in sensing of one or more objects.

The invention also relates to computer program products enabling a computer system to perform such a method.

### BACKGROUND OF THE INVENTION

Joint communication and sensing (JCAS) is considered as one of the important 6G candidate technologies in which the same system/network is used to perform both communication and sensing tasks. In this context, the term sensing typically refers to detection and/or tracking of a target object, which may or may not be connected (or able to connect) to the mobile network in a communications sense. Use cases include real-time object detection for autonomous driving, home intruder detection, UAV detection, and UAV flight control/coordination, and real-time monitoring including high-precision localization of objects for industrial applications. A target object may have different attributes, e.g. shape, size, velocity, distance, location, orientation, type of material, color, temperature, heartbeat, pitch, yaw, and/or roll.

In sensing, a distinction is made between surveillance mode and tracking mode. In surveillance mode, the sensing objective is to detect the presence of a target object, typically including detection of one or more of the aforementioned object's attributes, e.g. its location. In tracking mode, the sensing objective is to follow the trajectory of a sensed target object, typically requiring the estimation of the object's speed, changes therein and its direction of movement.

Base stations (abbreviated as BS) and/or regular mobile terminals, i.e. UEs (User Equipment), may be used as JCAS node, for example. For instance, a base station may communicate with regular mobile terminals, while being meanwhile used to sense/detect one or more objects. At least one JCAS node emits a radio signal, which is reflected by objects in the neighborhood. The reflected signals are received by at least one JCAS node and can be processed to detect the attributes of the objects, e.g. the above-mentioned attributes.

The paper “Enabling Joint Communication and Radar Sensing in Mobile Networks—A Survey” by J. A. Zhang et al., in IEEE Communications Surveys & Tutorials, vol. 24, no. 1, pp. 306-345, First quarter 2022, provides a survey of different technologies for realizing JCAS. With regard to the design of the radio signal used for sensing, in general, the following options exist:
1. A dedicated sensing signal is designed for the purpose of sensing, multiplexed with other sensing and/or communication signals in the code-, time, frequency, and/or spatial domains. An advantage of this option is that the waveform is optimized for the purpose of sensing, which ultimately leads to a higher sensing performance. A disadvantage of this option is that the same signal cannot be used simultaneously for communication and sensing purposes, which may result in a higher resource consumption (e.g. time, frequency or power) than options 2 and 3.
2. A same (new) radio signal (waveform) is designed for both communication and sensing purposes, jointly taking into account the requirements of communication and sensing. An advantage of this option with respect to the design and implementation of both dedicated sensing and communication signals a lower implementation complexity. Use of such signals (waveforms) further might lead to a relatively high resource efficiency when the signal is used simultaneously for communication and sensing purposes, since no resources need to be exclusively used for a dedicated sensing signal. A disadvantage of this option with respect to option 1 is that the performance of both communication and sensing are compromised, since the requirements of communication and sensing differ significantly.
3. A conventional communication radio signal (waveform), designed for the purpose of communication, is used for both communication and sensing purposes. An advantage of this option is that the used waveforms are optimised for communication tasks; there is no need to design a new waveform for the purpose of sensing. Since existing communication systems such as 5G and Wi-Fi may be used, existing hardware/devices may be used (possibly with a software update). An advantage of this option with respect the use of both dedicated sensing and communication signals is a relatively high resource efficiency when the signal is used simultaneously for communication and sensing purposes, since no resources need to be exclusively used for a dedicated sensing signal. A disadvantage of this option with respect to options 2 and 3 is a possibly sub-optimal sensing performance, since communication signals are not designed/optimized for the purpose of sensing. In this option, e.g. common reference signals and/or signals with communication payload may be used for the purpose of sensing.

A dense deployment of cellular networks facilitates enormous sensing opportunities. In the above-mentioned paper “Enabling Joint Communication and Radar Sensing in Mobile Networks-A Survey”, different existing communication channels/signals in 5G NR are identified as suitable for sensing such as reference signals (e.g. DL/UL DM-RS, UL SRS, DL CSI-RS), synchronization signals (e.g. DL SSBs) and payload signals (e.g. DL PDSCHs and UL PUSCHs).

The technologies described in the aforementioned paper do not address selecting a subset of nodes for a given sensing task and do not recognize that it may not be ideal to use all available nodes for a given sensing task. Even when using the same signals simultaneously for communication and sensing purposes, each receiving node may experience a reduction in communication performance; while receiving nodes are receiving wireless signals for the purpose of sensing, they are unable to receive communication signals intended for them or to transmit communication signals. Furthermore, as receiving nodes will typically transmit sensing reports wirelessly, they will need to use additional time-frequency resources which may not only reduce their own communication performance, but also the communication performance of other nodes. These reductions in communication performance often reduce the efficiency of the joint communication and sensing system.

### SUMMARY OF THE INVENTION

It is a first objective of the invention to provide a system, which is able to efficiently satisfy requirements of both communications and sensing tasks in a joint communication and sensing system.

It is a second objective of the invention to provide a method, which can be used to efficiently satisfy requirements of both communications and sensing tasks in a joint communication and sensing system.

In a first aspect of the invention, a system for enabling sensing of one or more objects includes at least one processor configured to obtain sensing requirements for sensing the one or more objects, obtain communication requirements, obtain information on each of a collection of nodes, select a set of nodes from the collection of nodes based on the sensing requirements, the communication requirements, and the information on each of the collection of nodes, instruct one or more nodes of the set of nodes to participate in sensing the one or more objects, at least one node of the set of nodes transmitting wireless signals and at least one node of the set of nodes receiving the wireless signals.

The at least one processor may be configured to obtain characteristics of the received wireless signals, the received wireless signals comprising received versions of the transmitted wireless signals, the received wireless signals reflecting an impact of the one or more objects on the transmitted wireless signals, and determine, or enable another system to determine, one or more physical properties of each of the one or more objects based on the characteristics of the received wireless signals.

To efficiently satisfy requirements of both communications and sensing tasks, the system is able to select a (proper) subset of the collection of nodes to conduct a given sensing task. By selecting the set of nodes (e.g. BSs and UEs) based on sensing requirements, communication requirements, and information on each of the collection of nodes, nodes may be selected such that there is an efficient use of time-frequency resources and/or transmission power and optionally node (e.g. computational) resources while satisfying the requirements of both communication and sensing tasks, e.g. the requirements of on-going communication/sensing tasks and one or more newly given sensing tasks. Since there is an inherent trade-off between sensing and communications utilizing the same resources, it is beneficial to take this trade-off into account and for example select nodes whose involvement in the sensing task would benefit the sensing performance substantially without costing too much in terms of communication performance. The operator of the mobile communication network may define in an operator policy how this trade-off should be implemented.

At certain moments, it may be sufficient to select the set of nodes based only on the sensing requirements and the information on each of the collection of nodes and not based on the communication requirements, e.g. when there are no communication tasks.

The sensing requirements may, for example, specify one or more of one or more targeted areas, one or more targeted directions, one or more targeted object types, one or more targeted objects (e.g. one or more object identifiers), targeted object velocities, targeted object sizes, and sensing performance requirements. The sensing performance requirements may specify requirements on sensing accuracy, sensing urgency, and/or sensing reliability, for example. The sensing accuracy requirement may comprise a targeted range resolution, for example. The sensing reliability requirement may comprise a minimum likelihood of detection and a limit on the false alarm rate, for example.

The transmissions may use dedicated sensing signals, a waveform which has been designed for both communication and sensing, or a waveform which has not been designed for sensing but only for communication. The latter has an advantage that an anyway transmitted communications signal may be exploited for an additional purpose, i.e. for a sensing task. On the other hand, when dedicated sensing signals are specifically emitted for a given sensing task, resources are explicitly consumed by the sensing task and hence may be unavailable for performing communications tasks by one or more nodes. It is beneficial to take this into account when selecting the subset of nodes. In this way, the impact of the use of dedicated sensing signals on other nodes may be reduced.

A node may be a UE or a BS, for example. The wireless signals may be received by a different node than the node which transmits the wireless signals. A single node may be both a transmitting node and a receiving node. The physical properties of the one or more objects that are targets for the sensing task may include one or more of shape, size, velocity, distance, location, orientation, type of material, color, temperature, heartbeat, pitch, yaw, and roll, for example. The system may be a BS, a UE or another system in the radio access network, for example.

The information on each of the collection of nodes may indicate one or more of node location, cell-specific antenna settings, cell-specific carrier frequency, cell load, current set of actively transmitted reference signals, maximum transmit power, receiver characteristics, and supported frequency bands. This information may include node characteristics and characteristics of paths between nodes. The latter may include the average channel gain on the radio link between a transmitting node and a receiving node, for example. The average channel gain and the cell load may be used to estimate whether communication performance requirements can be met. The foregoing is a non-exhaustive list of examples that may be used to determine communication performance and/or sensing performance in the process of selecting the set of nodes.

The at least one processor may be configured to assign each respective node of the set of nodes to a first set of transmitting nodes and/or a second set of receiving nodes, the first set of transmitting nodes transmitting the wireless signals and the second set of receiving nodes receiving the wireless signals.

In certain situations, it may not be necessary to assign a role to each selected node, e.g. because all UEs are only receiving nodes and all BSs are only transmitting nodes or because all nodes are both a receiving node and a transmitting node. However, it may be possible to achieve a better efficiency or better communications (and/or sensing) performance by assigning a role to each selected node. For example, the use of a certain BS as a transmitting node and a certain UE as a receiving node may result in a better efficiency or performance than the use of the certain BS as a receiving node and the certain UE as a transmitting node. The assignment of the roles may be performed at the same time as selecting the nodes.

The at least one processor may be configured to instruct the second set of receiving nodes to receive the wireless signals for the (sole or additional) purpose of sensing the one or more objects. If roles are assigned by the system and only unadjusted wireless communication signals are transmitted, then it may be sufficient if the system only instructs the receiving nodes. Alternatively, the roles might not be assigned by the system. In this case, a node's role may be configured in the node, e.g. BSs may only be able to act as transmitting node and UEs may only be able to act as receiving node, or each node may be both a transmitting node and a receiving node (bi-static).

The at least one processor may be configured to instruct the first set of transmitting nodes to transmit the wireless signals for the sole or additional purpose of sensing the one or more objects. This is beneficial if the wireless signals include a wireless communication signal adjusted for the purpose of sensing the one or more objects and/or a dedicated sensing signal, for example. The wireless communication signal may be adjusted by adjusting its beam characteristics or by adjusting its scheduled frequency and time resources compared to a wireless communication signal transmitted only for a communication purpose. For example, a repetition interval of a reference signal may be adjusted. If only unadjusted wireless communication signals are transmitted, then it may not be necessary to instruct the transmitting node(s).

The at least one processor may be configured to form a plurality of candidate node combinations from the collection of nodes, each of the plurality of node combinations comprising a first subset and a second subset of the collection of nodes, the first subset being assigned the role of transmitting the wireless signals and the second subset being assigned the role of receiving the wireless signals, determine, for each of the plurality of node combinations, based on the information on each of the collection of nodes, at least one communication performance for at least one communication task and at least one sensing performance for at least one sensing task, determine for each of the plurality of node combinations, based on the at least one communication performance and the at least one sensing performance, whether the communication requirements and sensing requirements can be met, select a node combination of the plurality of node combinations as the set of nodes based on one or more of the at least one communication performance and the at least one sensing performance and based on whether the communication requirements and sensing requirements can be met, and assign the first subset of the selected node combination to the first set and the second subset of the selected node combination to the second set.

This makes it possible to consider the inherent trade-off between sensing and communications in a suitable manner, typically according to the network operator's policy. Any induced resource costs (e.g. code, power, time, frequency) may cause a loss in communication performance due to the reduced availability of said resources for handling communication tasks.

At certain moments, it may be sufficient to determine only a sensing performance for a sensing task and not determine a communication performance for a communication task, e.g. when there are no communication tasks. In this situation, the processor may determine for each of the plurality of node combinations, based on the at least one sensing performance, whether the sensing requirements can be met, and may select a node combination of the plurality of node combinations as the set of nodes based on the at least one sensing performance and based on whether the sensing requirements can be met.

Typically, the node selection is performed upon the arrival of a new sensing request based on the requirements of that new task and of any existing tasks. The existing tasks may be: (i) none; (ii) only communication tasks; (iii) only other sensing tasks; or (iv) a mix of communication tasks and other sensing tasks.

The at least one processor may be configured to determine the sensing performances by determining, for each node combination of the plurality of node combinations, for each sensing task of the at least one sensing task, a probability of detection based on the roles assigned to the nodes in the node combinations. For instance, the combination of nodes with at least a minimum required probability of detection, meeting the communication requirements, and yielding the lowest processing cost may be selected. Alternatively, the combination of nodes with the highest probability of detection, meeting the communication requirements, and optionally yielding at most a maximum processing cost may be selected, for example.

The at least one processor may be configured to determine, for each respective node combination of the plurality of node combinations, a processing cost at the second subset of the respective node combination based on the information on each of the collection of nodes, and select the node combination as the set of nodes further based on the processing costs. The processing costs may be determined, for example, based on one or more of whether the node is a BS or a UE, whether the node is active or idle, the node's processing load, the node's sensing capabilities, and the node's battery level. Normally, each receiving node participating in the sensing is faced with a processing cost and this is an additional reason why it may not be ideal to use all available nodes for a given sensing task.

The at least one processor may be configured to select a plurality of candidate nodes from the collection of nodes based on the information on each of the collection of nodes, and select the set of nodes from the plurality of candidate nodes based on the sensing requirements, the communication requirements, and the information. If selecting the set of nodes from the plurality of candidate nodes based on the sensing requirements, the communication requirements, and the information involves complex calculations, e.g. as part of an optimization algorithm, whose complexity increases with the number of nodes being considered, then it may be beneficial to prefilter the collection of nodes and perform the complex calculations only with respect to a more limited number of candidate nodes.

For example, the information on each of the collection of nodes may indicate a willingness and/or capability of a respective node to participate in the sensing of the one or more objects and/or indicates a proximity of a respective node to a target area, the target area being specified in the sensing requirements and the at least one processor may be configured to select the plurality of candidate nodes based on the willingness and/or the capability of the nodes to participate in the sensing and/or based on the proximity of the nodes to the target area. In the latter case, a node might only be included as candidate node if the coverage area (transmission and/or reception) of the node has, or is estimated to have, at least a certain amount of overlap with the target area, for example.

In a second aspect of the invention, a node for participating in sensing of one or more objects may include at least one processor configured to receive, from a system for enabling sensing of one or more objects, an instruction to participate in sensing the one or more objects, and based on the instruction, transmit and/or receive wireless signals for the purpose of sensing the one or more objects, the received wireless signals comprising received versions of the transmitted wireless signals, the received wireless signals reflecting an impact of the one or more objects on the transmitted wireless signals.

The instruction may specify whether the node should transmit, receive, or transmit and receive the wireless signals for the purpose of sensing the one or more objects and the at least one processor of the node may be configured to transmit, receive, or transmit and receive the wireless signals in dependence on the instruction.

In a third aspect of the invention, a method of enabling sensing of one or more objects includes obtaining sensing requirements for sensing the one or more objects, obtaining communication requirements, obtaining information on each of a collection of nodes, selecting a set of nodes from the collection of nodes based on the sensing requirements, the communication requirements, and the information on each of the collection of nodes, and instructing one or more nodes of the set of nodes to participate in sensing the one or more objects, at least one node of the set of nodes transmitting wireless signals and at least one node of the set of nodes receiving the wireless signals. The method may be performed by software running on a programmable device. This software may be provided as a computer program product.

In a fourth aspect of the invention, a method of participating in sensing of one or more objects includes receiving, from a system for enabling sensing of one or more objects, an instruction to participate in sensing the one or more objects and, based on the instruction, transmitting and/or receiving wireless signals for the purpose of sensing the one or more objects, the received wireless signals comprising received versions of the transmitted wireless signals, the received wireless signals reflecting an impact of the one or more objects on the transmitted wireless signals. The method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a first software code portion, the first software code portion, when executed or processed by a computer, being configured to perform executable operations for enabling sensing of one or more objects.

The executable operations include obtaining sensing requirements for sensing the one or more objects, obtaining communication requirements, obtaining information on each of a collection of nodes, selecting a set of nodes from the collection of nodes based on the sensing requirements, the communication requirements, and the information on each of the collection of nodes, and instructing one or more nodes of the set of nodes to participate in sensing the one or more objects, at least one node of the set of nodes transmitting wireless signals and at least one node of the set of nodes receiving the wireless signals A non-transitory computer-readable storage medium stores at least a second software code portion, the second software code portion, when executed or processed by a computer, being configured to perform executable operations for participating in sensing of one or more objects.

The executable operations include receiving, from a system for enabling sensing of one or more objects, an instruction to participate in sensing the one or more objects and, based on the instruction, transmitting and/or receiving wireless signals for the purpose of sensing the one or more objects, the received wireless signals comprising received versions of the transmitted wireless signals, the received wireless signals reflecting an impact of the one or more objects on the transmitted wireless signals. The method may be performed by software running on a programmable device. This software may be provided as a computer program product.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the method of enabling sensing of one or more objects;

FIG. 2 is a flow diagram of an embodiment of the method of participating in sensing of one or more objects;

FIG. 3 is a flow diagram of a second embodiment of the method of enabling sensing of one or more objects;

FIG. 4 is a flow diagram of a third embodiment of the method of enabling sensing of one or more objects;

FIG. 5 exemplifies the selection of candidate nodes with the method of FIG. 4;

FIG. 6 is a flow diagram of a fifth embodiment of the method;

FIG. 7 exemplifies the determination of a probability of detection in a first implementation of the method of FIG. 6;

FIG. 8 exemplifies the determination of a probability of detection in a second implementation of the method of FIG. 6;

FIG. 9 is a block diagram of a first embodiment of the system;

FIG. 10 is a block diagram of a second embodiment of the system; and

FIG. 11 is a block diagram of an exemplary data processing system for performing the method of the invention.

Corresponding elements in the drawings are denoted by the same reference numeral.

### DETAILED DESCRIPTION OF THE DRAWINGS

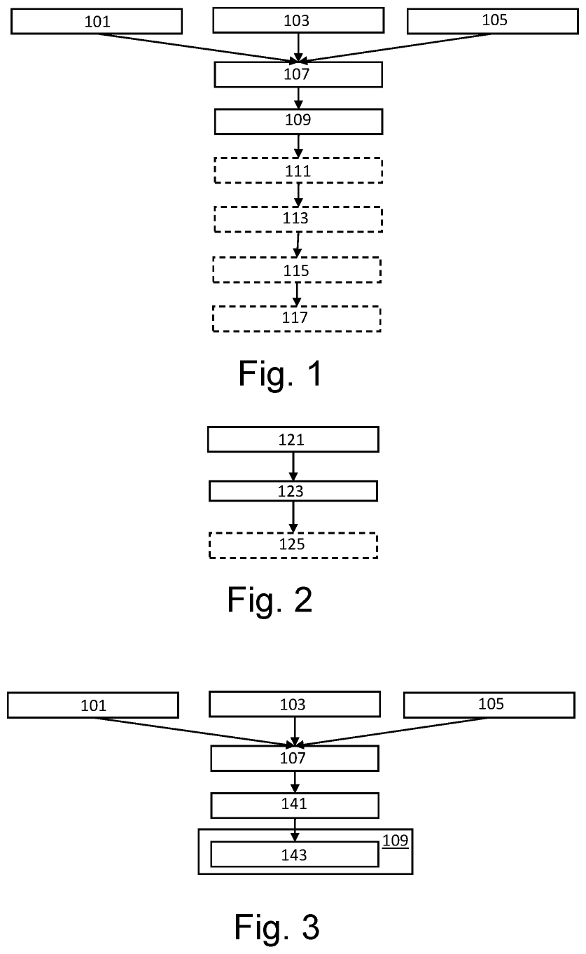

A first embodiment of the method of enabling sensing of one or more objects is shown in FIG. 1. In this embodiment, the steps of the method are performed by a single system. A step 101 comprises obtaining sensing requirements for sensing the one or more objects. The sensing requirements typically relate to any on-going sensing tasks, and if applicable, a newly requested sensing task. The sensing requirements may, for example, specify one or more of: one or more targeted areas, one or more targeted directions, one or more targeted object types, one or more targeted objects (e.g. one or more object identifiers), targeted object velocities, targeted object sizes, and sensing performance requirements. The sensing performance requirements may specify requirements on sensing accuracy, sensing urgency, and/or sensing reliability, for example. The sensing accuracy requirement may comprise a targeted range resolution, for example. The sensing reliability requirement may comprise a minimum likelihood of detection and a limit on the false alarm rate, for example.

In an implementation, the sensing requirements include a task description and performance requirements. The task description may indicate the ‘where’ (e.g. in a well-defined area around Amsterdam), ‘when’ (e.g. today between 2-4 pm), and ‘what’ (e.g. a flying drone/device of measurements [H (height), B (breadth), L (length)] with H_{MIN}<H<H_{MAX}, B_{MIN}<B<B_{MAX}, L_{MIN}<L<L_{MAX}). The sensing performance requirements may prescribe detection of the target object within x seconds of its entering the area or of initiating the sensing task, successful detection probability >y, and/or false alarm rate <z, for example. Specific values for these parameters (related to the task description and the performance requirements) may be provided by an external application.

The sensing requirements may, for example, relate to surveillance mode or a tracking mode:
In surveillance mode, the sensing objective is to detect the presence of a target object, typically including one or more of the aforementioned object's attributes, e.g. its location. Possible sensing requirements include the detection range, detection accuracy and detection speed (time needed), with individual such requirements potentially imposed for any targeted attribute of the object.
In tracking mode, the sensing objective is to follow the trajectile of a sensed target object, typically requiring the estimation of the object's speed, changes therein and its direction of movement. Possible sensing requirements include the maximum detectable speed, granularity of speed detection and movement direction, with individual such requirements potentially imposed for any targeted attribute of the object or the object's trajectory.

Both the surveillance mode and the tracking mode may be enhanced by further determining the shape and orientation of the detected/tracked target object. Possible sensing requirements here are the orientation accuracy and shape accuracy.

A step 103 comprises obtaining communication requirements, e.g. requirements with respect to throughput, latency, and/or reliability level. The communication requirements typically relate to any on-going communication tasks, and if applicable, a newly requested communication task. A step 105 comprises obtaining information on each of a collection of nodes. The information may comprise static parameters and/or dynamic parameters. Two non-exhaustive lists of selected examples are provided below:

### Static Parameters:

BS/cell locations
Cell-specific azimuth/tilt/antenna aspects/maximum transmit power
Sensing (tx/rx) capabilities of BSs
Carrier frequencies and bandwidths assigned to a cell
Sensitivity/noise figure/other characteristics of cell receivers

### Dynamic Parameters:

Current cell transmission/processing load of communications/sensing tasks and associated service requirements
Current set of actively transmitted CSI-RSs per cell
Set of UEs currently present and their characteristics (since the presence of UEs itself is dynamic, all UE-specific parameters are considered dynamic), e.g.
   UE locations
   Current UE transmission/processing load of communications/sensing tasks and associated service requirements
   Sensing (tx/rx) capabilities of UEs
   Frequency bands supported by a UE
   Sensitivity/noise figure/other characteristics of UE receivers
   Active/idle mode (UEs)
   Battery level of UEs
Battery level of battery-power cells

Steps 101, 103, and 105 may be performed in an information collection phase. Other information may also be collected in this information collection phase, e.g. the (usual) CSI feedback of the UEs.

A step 107 comprises selecting a set of nodes from the collection of nodes based on the sensing requirements obtained in step 101, the communication requirements obtained in step 103, and the information on each of the collection of nodes obtained in step 105. If a node selected in step 107 is a base station and this base station provides coverage for multiple cells, one of these multiple cells may also be selected in step 107.

Typically, the node selection is performed upon the arrival of a new sensing request based on the requirements of that new task and of any existing tasks. The existing tasks may be: (i) none; (ii) only communication tasks; (iii) only other sensing tasks; or (iv) a mix of communication tasks and other sensing tasks. If there are no communication tasks at a certain moment, step 103 may be skipped at that moment and the nodes may then be selected based on the sensing requirements obtained in step 101 and the information on each of the collection of nodes obtained in step 105, and not based on any communication requirements.

A step 109 comprises instructing one or more nodes of the set of nodes to participate in sensing the one or more objects. At least one node of the set of nodes will transmit wireless signals and at least one node of the set of nodes will receive the wireless signals.

Optionally, the method further comprises steps 111 and 113. Step 111 comprises scheduling frequency and time resources for and/or determining beam characteristics of beams for transmissions of wireless signals based on the sensing requirements obtained in step 101 and the communication requirements obtained in step 103. The wireless signals may include communication payload data, for example. Step 111 may comprise determining a beamwidth and/or a beam direction and/or a transmit power for one or more beams based on the sensing requirements obtained in step 101 and the communication requirements obtained in step 103, for example.

A step 113 comprises transmitting wireless signals, e.g. on the scheduled frequency and time resources scheduled in step 111 and/or via the beams with the beam characteristics determined in step 111. As mentioned previously, in general, the following options exist with regard to the design of the radio signal:
1. A dedicated sensing signal is used for the purpose of sensing, possibly multiplexed with other sensing and/or communication signals in the time, frequency, code, and/or spatial domains.
2. A same (new) radio signal (waveform) is designed for both communication and sensing purposes, jointly taking into account the requirements of communication and sensing.
3. A conventional communication radio signal, transmitted for the purpose of either a specific communications task or as e.g. a reference/control signal to support communication tasks, is additionally exploited for the purpose of a sensing task, possibly in a modified form.

In step 111, a choice is made among the available signal options, e.g. use the available communication signals and optionally use dedicated sensing signals. Optionally, steps 115 and 117 are performed after step 113 or after step 109 if steps 111 and 113 are omitted. Step 115 includes obtaining characteristics of received wireless signals which include received versions of the transmitted wireless signals and which reflect an impact of the one or more objects on the transmitted wireless signals. Characteristics of received wireless signals which do not include received versions of the transmitted wireless signals or do not reflect an impact of the one or more objects on the transmitted wireless signals do not need to be obtained in step 115.

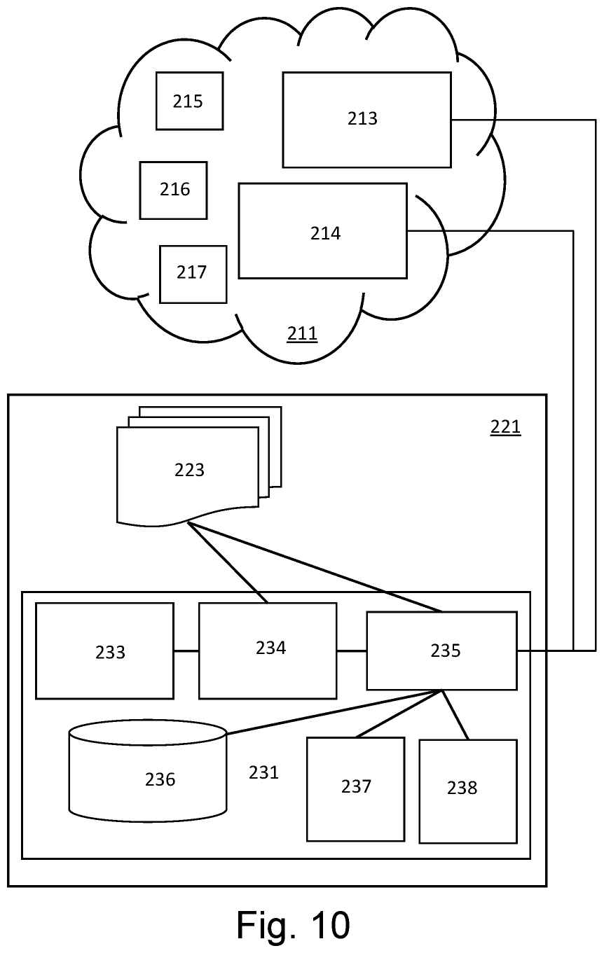

Step 117 includes determining, or enabling another system to determine, one or more physical properties of each of the one or more objects based on the characteristics of the received wireless signals, as obtained in step 115. The other system may be enabled to determine the one or more physical properties by transmitting, in step 117, to the other system, sensing data which comprises characteristics of the received signals obtained in step 115. The physical properties of the one or more objects may include, for example, one or more of shape, size, velocity, distance, location, orientation, type of material, color, temperature, heartbeat, pitch, yaw, and roll. If steps 115 and 117 are omitted, they may be performed by a further system, e.g. a Sensing Application Function (which will be described in relation to FIG. 10). Additionally, one or more steps of one or more of the embodiments of FIGS. 3, 4, and 6 may be added to the embodiment of FIG. 1.

An embodiment of the method of participating in sensing of one or more objects is shown in FIG. 2. In this embodiment, the steps of the method are performed by a single node. A step 121 comprises receiving, from a system for enabling sensing of one or more objects, an instruction to participate in sensing the one or more objects. This system may be the system which performs the method of FIG. 1, for example.

The instruction may specify whether the node should transmit, receive, or transmit and receive the wireless signals for the purpose of sensing the one or more objects. If the node is configured to always transmit, receive, or transmit and receive the wireless signals for the purpose of sensing the one or more objects, the instruction does not need to specify this.

A step 123 comprises, based on the instruction received in step 121, transmitting and/or receiving wireless signals for the purpose of sensing the one or more objects. The wireless signals received in step 123 include received versions of the transmitted wireless signals which reflect an impact of the one or more objects on the transmitted wireless signals. Other wireless signals may be received in another step (not shown in FIG. 2).

If step 123 comprises receiving wireless signals for the purpose of sensing the one or more objects, optional step 125 may be performed. Step 125 comprises determining, or enabling the system or another system to determine, one or more physical properties of each of the one or more objects based on the characteristics of the wireless signals received in step 123. The system or the other system may be enabled to determine the one or more physical properties by transmitting, in step 125, to the (other) system, sensing data which comprises characteristics of the signals received in step 123.

A second embodiment of the method of enabling sensing of one or more objects is shown in FIG. 3. The second embodiment of FIG. 3 is an extension of the first embodiment of FIG. 1. In the embodiment of FIG. 3, a step 141 is performed between steps 107 and 109 of FIG. 1 and step 109 of FIG. 1 is implemented by a step 143.

Step 141 comprises assigning each respective node of the set of nodes selected in step 107 to a first set of transmitting nodes and/or a second set of receiving nodes. The first set of transmitting nodes will transmit the wireless signals and the second set of receiving nodes will receive the wireless signals. Step 143 comprises instructing the second set of receiving nodes, as identified in step 141, to receive the wireless signals for the purpose of sensing the one or more objects.

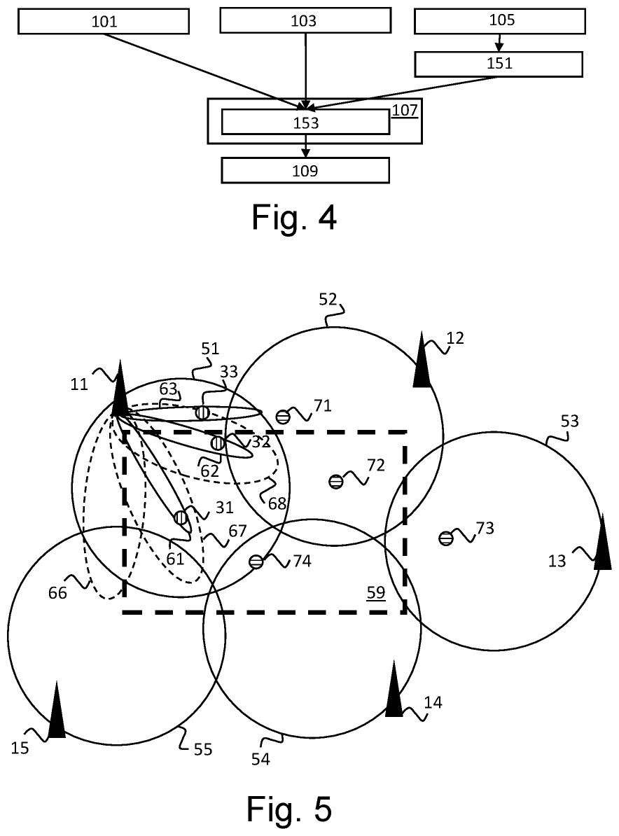

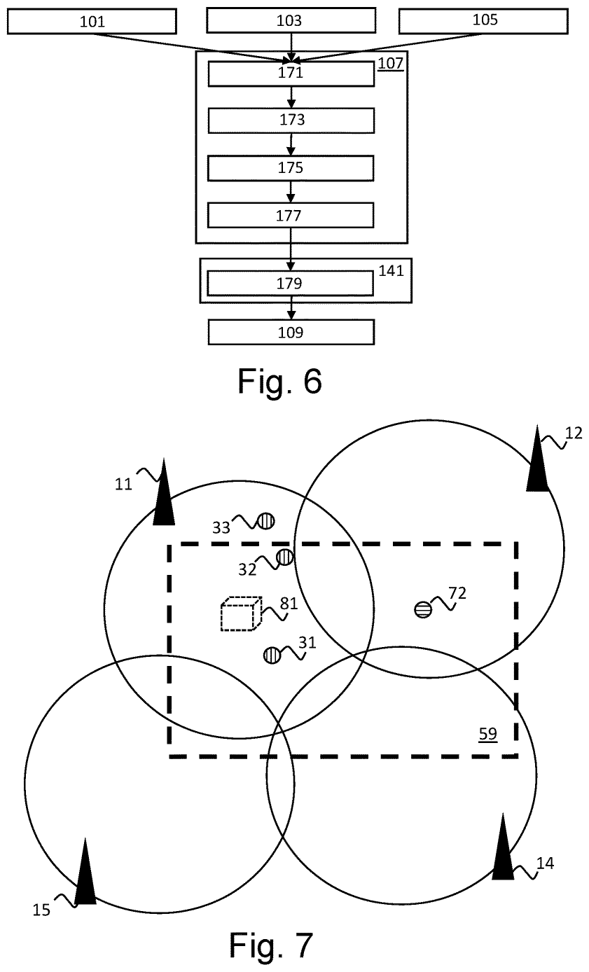

Optionally, step 143 comprises instructing the first set of transmitting nodes, as identified in step 141, to transmit the wireless signals for the sole or additional purpose of sensing the one or more objects. The latter is beneficial, for example, when the wireless signals include a wireless communication signal adjusted for the purpose of sensing the one or more objects (e.g. in optional steps 111 and 113, as described in relation to FIG. 1), and/or a dedicated sensing signal. Additionally, one or more steps of one or more of the embodiments of FIGS. 4 and 6 may be added to the embodiment of FIG. 3.

A third embodiment of the method of enabling sensing of one or more objects is shown in FIG. 4. The third embodiment of FIG. 4 is an extension of the first embodiment of FIG. 1. In the embodiment of FIG. 4, a step 151 is performed after step 105 of FIG. 1 has been performed, before step 107 of FIG. 1 is performed, and step 107 of FIG. 1 is implemented by a step 153.

Step 151 comprises selecting a plurality of candidate nodes from the collection of nodes based on the information on each of the collection of nodes, as obtained in step 105. Step 153 comprises selecting the set of nodes from the plurality of candidate nodes selected in step 151 based on the sensing requirements obtained in step 101, the communication requirements obtained in step 103, and the information obtained in step 105.

In step 151, a candidate set (shortlist) of nodes (BS and/or UE) is derived, e.g. based on network planning data. This reduces the complexity of the optimization problem that is typically solved in step 153. The more extensive the list of candidate nodes, the harder the optimization (selection) problem in step 153, but potentially also the better the eventual node selection and consequently the higher the sensing accuracy (e.g. lower ambiguity) and/or the lower the resource cost. The candidate set of nodes is therefore preferably too large than too small.

The information obtained in step 105 may, for example, indicate a willingness and/or capability of a respective node to participate in the sensing of the one or more objects and/or indicate a proximity of a respective node to a target area specified in the sensing requirements. For instance, the information obtained in step 105 may specify sensing (transmission/reception) capabilities of BSs and UEs from which this capability may be determined and/or BS/cell and/or UE locations from which this proximity may be determined. Considering the sensing capabilities in step 151 allows incapable nodes to be filtered out immediately.

Step 151 may then comprise selecting the plurality of candidate nodes based on this willingness and/or this capability of the nodes to participate in the sensing and/or based on this proximity of the nodes to the target area. If a base station is selected in step 151, one or more associated cells may also be selected in step 151. For example, one cell of a base station may be sufficiently close to a target area while another cell of the base station may not be sufficiently close to the target area.

In a relatively simple implementation of step 151, the candidate nodes are selected only based on their location relative to the target area and optionally their sensing capabilities. The example of FIG. 5 shows five base stations 11-15, their respective coverage areas 51-55, three active UEs 31-33, four idle UEs 71-74, and a target sensing area 59. In the example of FIG. 5, each base station provides coverage to a single cell. In this example, base stations 11, 12, 14, and 15 are selected as candidates, as base station 13 offers negligible coverage in the target sensing area 59.

Furthermore, in the example of FIG. 5, all UEs (active or idle) located within the target sensing area 59 are labeled as candidates, i.e. UEs 31, 32, 72, and 74. Additionally, UEs outside yet close to the boundary of the target sensing area 59 may also be considered as candidates, e.g. only if they would be needed to contribute to fully covering the target sensing area 59. For example, UE 71 may additionally be selected as candidate node. UE 33 may be considered to not be needed to contribute to fully covering the target sensing area 59 and therefore be omitted from the candidate selection. UE 73 may be considered not to be close to the target sensing area 59 and therefore be omitted from the candidate selection. The locations of active UEs may be known or estimated based on recent data, while the location of idle UEs may be estimated based on historical data (e.g. fixed or relatively slow moving UEs).

Dedicated sensing signals may affect communication performance and may consume additional resources. If supported, it may be beneficial to avoid their use where possible. Instead, wireless signals with communication payload and/or communication reference signals may be simultaneously used for the purposes of communication and sensing. In this case, the probability of detection of a target object in the target sensing area 59 depends at least on the locations of the nodes and optionally on the overlap between the coverage areas of the payload and reference signals and the target area 59.

The coverage areas 66-68 of three cell-specific SSB signals and the coverage areas 61-63 of the three CSI-RS signals received by UEs 31-33, respectively, are shown in FIG. 5. Not necessarily all SSB beams in the SSB Grid-of-Beams are considered for use in sensing. This may depend on their beam-specific overlap with the target sensing area 59. In the example of FIG. 5, the SSB corresponding to coverage area 66 from base station 11 may be excluded.

In a more advanced implementation of step 151, the degree of coverage overlap of reference signals with the target sensing area 59 is taken into account when selecting the candidates. In addition to the degree of overlap between the target sensing area 59 and the coverage areas of the SSB and CSI-RS signals transmitted by the base stations, the degree of overlap between the target sensing area 59 and the coverage area of the SRS signals transmitted by the UEs may be taken into account. These coverage areas can be approximated by a circle of some radius around a UE location (not visualized in FIG. 5). Additionally, one or more steps of one or more of the embodiments of FIGS. 3 and 6 may be added to the embodiment of FIG. 4.

In the embodiment of FIG. 4, static and dynamic parameters are obtained for all nodes of the collection of nodes in step 105 before the candidate nodes are selected in step 151. In an alternative embodiment, all parameters necessary to perform step 151 are obtained in step 105 for all nodes of the collection of nodes and all additional parameters necessary to perform step 153 are obtained for only the candidate nodes in an additional step performed between steps 151 and 153.

A fourth embodiment of the method of enabling sensing of one or more objects is shown in FIG. 6. The fourth embodiment of FIG. 6 is an extension of the first embodiment of FIG. 1. In the embodiment of FIG. 6, step 107 of FIG. 1 is implemented by steps 171, 173, 175, and 177 and, like in the embodiment of FIG. 3, a step 141 is performed between steps 107 and 109, which is implemented by a step 179 in the embodiment of FIG. 6.

Step 171 comprises forming a plurality of candidate node combinations from the collection of nodes. Each of the plurality of node combinations comprises a first subset and a second subset of the collection of nodes. The first subset is assigned the role of transmitting the wireless signals and the second subset is assigned the role of receiving the wireless signals. If the embodiment of FIG. 6 is combined with the embodiment of FIG. 4, the candidate node combinations comprise only candidate nodes selected in step 151 of FIG. 4.

First, a set of transmitters, denoted as M, and a set of receivers, denoted as N, may be determined based on the sensing capabilities of the nodes. These sensing capabilities may exclude a certain role for a node, e.g. a certain node may only be able to act as a receiver. The carrier frequencies assigned to a cell and the frequency bands supported by a UE may be considered in step 171, as the selected carrier frequency must be supported at both the transmitter and receiver(s); a UE cannot be assigned a transmission or reception role on a carrier in an unsupported frequency band.

In step 171, node combinations may be formed for each possible subset Mₛ⊆M and each possible subset Nₛ⊆N. There may be multiple node combinations with the same nodes, e.g. when different configurations are evaluated for one or more of the nodes. As a first example, in a first node combination, a first cell of a base station may be considered and in a second node combination, a second cell of this base station may be considered. As a second example, a base station transmits dedicated sensing signals in a first node combination but does not transmit dedicated sensing signals in a second node combination.

Step 173 comprises determining, for each of the plurality of node combinations, based on the information on each of the collection of nodes obtained in step 105, at least one communication performance for at least one communication task and at least one sensing performance for at least one sensing task. The communication and sensing performances may be determined for all on-going tasks and for any new tasks, for example.

Steps 101-109 may be repeated each time a new task is added, and optionally each time a task is removed, for example.

If there are no communication tasks at a certain moment, performing step 173 at that moment may involve determining, for each of the plurality of node combinations, based on the information on each of the collection of nodes obtained in step 105, at least one sensing performance for at least one sensing task, without determining any communication performances,

The sensing performances may be determined in step 173 by determining, for each node combination of the plurality of node combinations, for each sensing task of the at least one sensing task, a probability of detection based on the roles assigned to the nodes in the node combinations. The sensing performance may be equal to the probability of detection or may be a metric integrating the probability of detection under some conditions related to false alarm rate, sensing accuracy and/or sensing time, for example.

To determine the probability of detection, the BS/cell and UE locations may be taken into account, as the BS/cell and UE locations relative to a potential location of the sensing object will affect the propagation loss, the S(I)NR estimate and consequently the probability of detection. To determine the probability of detection, the cell-specific azimuth/tilt/antenna aspects/maximum transmit power and the carrier frequencies assigned to a cell may be taken into account, as these parameters affect the propagation loss, the S(I)NR estimate and consequently the probability of detection. To determine the probability of detection, the sensitivity/noise figure/other characteristics of cell/UE receivers may be taken into account, as these parameters affect the S(I)NR estimate and consequently the probability of detection.

The probability of detection may be calculated by applying radar equations first at pixel (part of the target sensing area) level and then integrating these over the target sensing area. An example of how the probability of detection may be calculated is given below. To estimate the probability of detection, the target sensing area is divided into a set of non-overlapping pixels, either in the two- or three-dimensional space, depending on the dimensionality of the target sensing area, as shown in FIG. 7.

FIG. 7 shows a 3D pixel 81 at a certain location in the target sensing area in addition to base stations 11-12 and 14-15 and UEs 31-33 and 72 of FIG. 5. The probability of detection for each node combination may first be estimated for each pixel of the target sensing area as follows:
i. Calculate/estimate the distances between all the receivers from Nₛ and the target 3D-pixel (R_{R,j})
ii. Calculate/estimate the distances between all the transmitters from Mₛ and the 3D-pixel (R_{T,i}),
iii. Calculate/estimate the received signal power for all the pairs:

$${S}_{i , j} = \frac{( \frac{{P}_{T , i} {G}_{T , i} {G}_{R , j} {λ}^{2} {F}_{T , i}^{2} {F}_{R , j}^{2}}{{( 4 π )}^{2} π {L}_{T , i} {L}_{R , j}} )}{{R}_{T , i}^{2} {R}_{R , j}} {σ}_{i , j}$$

where, i∈{1, . . . , card( [symbol] ₛ)} and j∈{1, . . . , card(Nₛ)} and

| | |
|---|---|
| σ_{i, j} | the (bistatic) Radar Cross-Section (RCS) of a |
| | given pair (i, j) |
| λ | central wavelength |
| P_{T, i} | transmission power of the i-th transmitter |
| G_{T, i}, G_{R, j} | antenna gains at transmitter, receiver |
| F_{T, i}, F_{R, j} | form factors |
| L_{T, i}, L_{R, j} | losses |
| R_{T, i}, R_{R, j} | distances |

iv. The combined SNR for considering the total number of receivers and transmitters in a given set further depends on whether the signals are combined (a) coherently or (b) incoherently.
   Assuming in a fully synchronized system operating in a coherent way, the combined SNR (for a particular pixel and a given set of transmitters and receivers) is given by

$$S N R = \frac{{( {\sum }_{j} {\sum }_{i} \sqrt{{s}_{i , j}} )}^{2}}{{\sum }_{j} 4 k {T}_{s} {B}_{j}} .$$

Alternatively, combining the signals in an incoherent way would yield a somewhat lower total SNR (for a particular pixel and a given set of transmitters and receivers), which is given by

$$S N R = \frac{{\sum }_{j} {\sum }_{i} {s}_{i , j}}{{\sum }_{j} 4 k {T}_{s} {B}_{j}} .$$

where,

| | |
|---|---|
| k | Boltzmann constant |
| Tₛ | equivalent system temperature |
| Bⱼ | the (noise) bandwidth at the j-th receiver |

v. Convert the total SNR into probability of detection (using a probability-of-detection vs SNR chart)

In the calculation (of the probability of detection) above, it was assumed to have signals (e.g. IQ-samples, plot-level information) from all receivers available at a sensing fusion center for aggregation. There are different ways to calculate the probability of detection which might be appropriate in some scenarios such as the absence of signals (IQ-samples) from all receivers at the fusion center, receiver able to process the sensing information locally. For instance, by assuming the receivers independently determine the receiver-specific probability of detection, P_{detection,j} could be calculated using the above mentioned steps. However, in this case, the proper adjustments in the equations in step (iii) and (iv-a) needs to be made, i.e. S_{i,j}→Sᵢ, σt_{i,j}→σᵢ,

$${R}_{{R}_{j}}^{2} \to {R}_{R}^{2} ,$$

Σⱼ Σᵢ→Σᵢ, Σⱼ→ could be calculated as, P_{detection}=1−Πⱼ∈Nₛ (1−P_{detection,j}), for example [symbol] This strategy assumes that one detection is enough. Other strategies are also possible.

The central wavelength, the transmission power of the i-th transmitter, the antenna gains, the form factors, the losses, the distances, the equivalent system temperature, and the (noise) bandwidth at the j-th receiver that are used in the calculation above may be determined from the information obtained in step 105. Normally, the manufacturer of the receiver specifies the system noise temperature (or the equivalent noise figure/factor, which could be converted to the noise temperature as Fs=1+Ts/290). The (bistatic) RCS of a given pair (i, j) may be determined from the sensing requirements obtained in step 101. For example, the sensing requirements may indicate an average/a minimum/a range of value(s) of the RCS for a given sensing task. Tables exist in the literature with average RCS values of certain objects, e.g. humans and airplanes.

The received signal power is calculated/estimated in step iii) per transmitter and receiver pair under the assumption that certain beams are transmitted. These beams may include beams for transmitting wireless signals with communication payload, beams for transmitting reference signals (e.g. SSB, CSI-RS, and/or SRS), and/or beams for transmitting dedicated sensing signals. The antenna gains and/or losses may be determined based on the beam characteristics of these beams. Even if a transmitter transmits a dedicated sensing signal, antenna gains and losses will normally vary between pixels of the target sensing area.

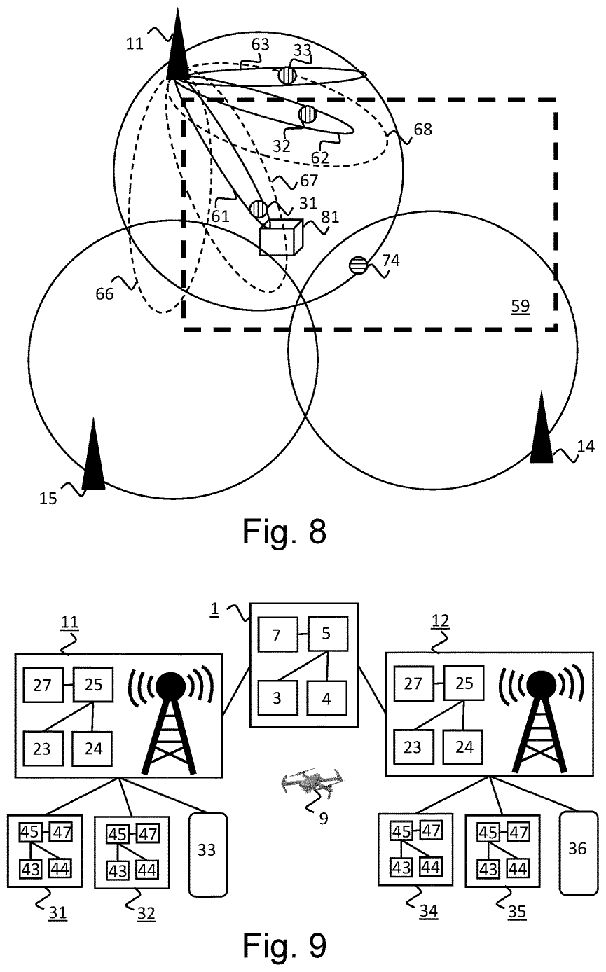

FIG. 8 shows a 3D pixel 81 at a certain location in the target sensing area 59 in addition to base stations 11, 14, and 15 and UEs 31-33 and 74 of FIG. 5. FIG. 8 further shows the coverage areas 66-68 of the three cell-specific SSB signals of FIG. 5 and the coverage areas 61-63 of the three CSI-RS signals of FIG. 5. If the base station 11 is selected as sensing transmitter and the UE 31 is selected as sensing receiver, a probability of detection for 3D pixel 81 may be calculated for moments at which the base station 11 transmits a wireless signal with communication payload, the CSI-RS signal with coverage area 61 or the SSB signal with coverage area 67.

Once the pixel-specific probabilities of detection have been estimated, the overall probability detection for the entire target sensing area is then determined by e.g. straightforward averaging of the pixel-specific probabilities of detection. Alternatively, weighted averaging may be used in case e.g. the targeted object is more likely present near the center of the target sensing area and it is therefore more important for the probability of detection in the more centrally located pixels to be high.

The overall probability of detection for the entire target sensing area is preferably estimated for a window of observation in which detection of the object(s) may be attempted multiple times. The probability of detection then increases with the number of attempts, as every additional attempt gives an additional opportunity for successful sensing. With pₙ the estimated probability at attempt n, 1−(1−p₁)*(1−p₂) * . . . * (1−p_{N}) may be used as estimated probability after N attempts. If a receiver receives a first beam with first beam characteristics from a transmitter at a first moment and a second beam with second beam characteristics from this transmitter at a second moment, the probability of detection will likely be different.

The communication performance may be estimated based on an average channel gain on the radio link between the transmitting node and the receiving node and on the cell load, for example. This communication performance may be reduced if a transmission opportunity is lost from a node due to the node being assigned the role of sensing receiver, i.e. when a BS acts as a sensing receiver in a downlink slot or a UE acts as a sensing receiver in an uplink slot. While a node is listening for wireless signals for the purpose of sensing, it cannot transmit wireless signals for the purpose of communication.

The communication performance may be reduced based on the impact of the lost transmission opportunity. The impact of the lost transmission opportunity may depend on cell load, priority of traffic, and/or latency tolerance, for example. The communication performance may also be reduced when a node is instructed to transmit a dedicated sensing signal or a for sensing purposes modified communication payload or reference signal.

In the determination of the impact of supporting a new sensing task on the communication performance, the current set of actively transmitted CSI-RSs per cell may be considered, e.g. to determine whether currently inactive CSI-RS signals or dedicated sensing signals would be needed for the cell to cover the currently uncovered areas and therefore additional transmission resources would be needed. In the determination of the impact of supporting a new sensing task on the communication performance, the mode (active or idle) of the UEs may also be considered, as idle UEs require additional signaling hence transmission resources to get involved in a sensing task.

Optionally, step 173 further comprises determining, for each respective node combination of the plurality of node combinations, a processing cost at the first subset of the respective node combination based on the information obtained in step 105. These processing costs may be determined, for example, based on one or more of the following parameters:
Sensing (tx/rx) capabilities of BSs and UEs
Processing capabilities of BSs and UEs
Battery level and energy usage or efficiency of UEs and battery-power cells
Current UE/BS processing load of communications/sensing tasks—the current processing load may affect the amount of processing resources a node can make available for a requested sensing task.

Step 175 comprises determining for each of the plurality of node combinations, based on the at least one communication performance and the at least one sensing performance determined in step 173, whether the communication requirements obtained in step 103 and the sensing requirements obtained in step 101 can be met. Thus, step 175 comprises comparing the at least one communication performance with the communication requirements and the at least one sensing performance with the sensing requirements. Steps 175 and 177 may be combined.

If there are no communication tasks at a certain moment, performing step 175 at that moment may involve determining for each of the plurality of node combinations, based on the at least one sensing performance determined in step 173, whether the sensing requirements obtained in step 101 can be met, without determining whether any communication requirements can be met.

Step 177 comprises selecting a node combination of the plurality of node combinations as the set of nodes based on one or more of the at least one communication performance and the at least one sensing performance determined in step 173, based on whether the communication requirements and sensing requirements can be met, as determined in step 175, and if applicable, based on the processing costs determined in step 173.

If there are no communication tasks at a certain moment, performing step 177 at that moment may involve selecting a node combination of the plurality of node combinations as the set of nodes based on the at least one sensing performance determined in step 173, based on whether the sensing requirements can be met, as determined in step 175, and if applicable, based on the processing costs determined in step 173, without selecting the node combination based on any communication performance or based on whether any communication requirements can be met.

In step 177, the aim may be to find the optimal sets M_{s,opt} and N_{s,opt} in line with the applicable operator policy, which typically specifies optimization of sensing and/or performance tasks under certain restrictions.

The operator policy may take various forms. If the estimated communication performance of communications task j is denoted with QoS_{c,j}, the corresponding minimum requirement (or maximum allowed level in case it is a KPI for which ‘lower is better’) is denoted with QoS_{c,j}*, the estimated sensing performance of sensing task j is denoted with QoS_{s,j}, and the corresponding minimum requirement (or maximum allowed level in case it is a KPI for which ‘lower is better’) is denoted with QoS_{s,j}*, the operator policy may be, for example, specified a follows:
to optimize the QoS_{x,j}, for a single (communications or sensing) task (x,j), while imposing conditions on the QoS_{y,j}, in view of QoS_{y,j}* for all other tasks (y,j), while optionally imposing a restriction on the processing cost not exceeding some maximum level;
to maximize α under the condition that QoS_{x,j}≥α QoS_{x,j}* for all (communications or sensing) tasks (x,j), while optionally imposing a restriction on the processing cost not exceeding some maximum level;
to maximize α weighted average of all QoS levels, i.e. to maximize β_{C,1}QoS_{C,1}+β_{C,2}QoS_{C,2}+ . . . +β_{S,1}QoS_{S,1}+β_{S,2}QoS_{S,2}+ . . . , while imposing conditions on the QoS_{x,j} in view of QoS_{x,j}* for all (communications or sensing) tasks (x,j), while optionally imposing a restriction on the processing cost not exceeding some maximum level.

For example, QoS_{c,j} may be a throughput, latency, reliability level, or some combination thereof, and QoS_{s,j} may be a probability of detection or a metric integrating the probability of detection under some conditions related to false alarm rate, sensing accuracy and/or sensing time. Combinations of the above are also possible. The above formulation assumes that for each QoS metric ‘higher is better’. In case of a QoS metric for which ‘lower is better’, e.g. in case of a latency-based metric, then the formulation should be suitably altered, e.g. by replacing the QoS metric and the corresponding requirement by its inverse.

The above approach should yield a solution that is (approximately) optimal with respect to the operator policy. If the sensing and communication performances are determined under the assumption that only unadjusted existing communication signals are used and no feasible solution is found or an extremely high processing-cost solution is found, additional actions such as utilizing dedicated sensing signals or reconfiguring/adjusting existing communication signals may need to be taken. Such actions potentially reduce communications performance.

Step 179 comprises assigning the first subset of the node combination selected in step 177, as formed in step 171, to the first set and the second subset of the node combination selected in step 177, as formed in step 171, to the second set. Step 109 comprises instructing one or more nodes of the set of nodes to participate in sensing the one or more objects. Additionally, one or more steps of one or more of the embodiments of FIGS. 3 and 4 may be added to the embodiment of FIG. 6. Step 109 may be implemented by step 143 of FIG. 3, for example.

FIG. 9 is a block diagram of a first embodiment of a communication network comprising a system for enabling sensing of one or more objects, system 1, and nodes for participating in the sensing of the one or more objects, base stations 11 and 12 and UEs 31-32 and 34-35. In this first embodiment, the system 1 is separate from the base stations and UEs and may be located in the radio access network, for example. The base stations 11 and 12 may comprise a plurality of distributed units that share a common centralized unit in a Centralized RAN (C-RAN) architecture, for example. In the embodiment of FIG. 9, three UEs 31-33 are connected to the base station 11 and three UEs 34-36 are connected to the base station 12.

The system 1 comprises a receiver 3, a transmitter 4, a processor 5, and a memory 7. The processor 5 is configured to obtain sensing requirements for sensing the one or more objects, e.g. object 9, obtain communication requirements, obtain information on each of a collection of nodes, select a set of nodes from the collection of nodes based on the sensing requirements, the communication requirements, and the information on each of the collection of nodes, and instruct, e.g. via base stations 11 and 12, one or more nodes of the set of nodes to participate in sensing the one or more objects. At least one node of the set of nodes will transmit wireless signals and at least one node of the set of nodes will receive the wireless signals.

In the embodiment of FIG. 9, the base stations 11 and 12 each comprise a receiver 23, a transmitter 24, a processor 25, and a memory 27. The processor 25 is configured to receive, from the system 1, via the receiver 23, an instruction to participate in sensing the one or more objects, and based on the instruction, transmit (via the transmitter 24) and/or receive (via the receiver 23) wireless signals for the purpose of sensing the one or more objects. The received wireless signals comprise received versions of the transmitted wireless signals. The received wireless signals reflect an impact of the one or more objects on the transmitted wireless signals.

In the embodiment of FIG. 9, the UEs 31-32 and 34-35 each comprise a receiver 43, a transmitter 44, a processor 45, and a memory 47. The processor 45 is configured to receive, from the system 1, via the receiver 43, an instruction to participate in sensing the one or more objects, and based on the instruction, transmit (via the transmitter 44) and/or receive (via the receiver 43) wireless signals for the purpose of sensing the one or more objects. Of the received wireless signals the wireless signals which include received versions of the transmitted wireless signals which reflect an impact of the one or more objects on the transmitted wireless signals are relevant for the purpose of sensing.

In the example of FIG. 9, UEs 33 and 36 have not been configured in a similar manner as UEs 31-32 and 34-35 and system 1 is not able to instruct UEs 33 and 36 to participate in the sensing of the one or more objects. However, base stations 11 and 12 and UEs 31-32 and 34-35 may be instructed in such a way that they will receive the wireless signals transmitted by UEs 33 and 36. UEs 33 and 36 may be selected as part of the set of nodes, but since they cannot be instructed, they can only be assigned a transmitting role (in which they transmitted unadjusted communication signals). If UE 33 and/or UE 36 are assigned a transmitting role, they will not, and do not need to, modify their behavior. In an alternative example, all nodes that are selected as part of the set of nodes by the system 1 are able to receive and execute an instruction from the system 1, as described in relation to base stations 11 and 12 and UEs 31-32 and 34-35.

The instruction that may be received from system 1 by base stations 11-12 and UEs 31-32 and 34-35 may specify whether the node should transmit, receive, or transmit and receive the wireless signals for the purpose of sensing the one or more objects. The processor 25 of the base stations 11-12 and the processor 45 of the UEs 31-32 and 34-35 may be configured to transmit, receive, or transmit and receive the wireless signals in dependence on this instruction.

In the embodiment shown in FIG. 9, the system 1 comprises one processor. In an alternative embodiment, the system 1 comprises multiple processors. The processor 5 may be a general-purpose processor, e.g., an Intel or an AMD processor, or an application-specific processor, for example. The processor 5 may comprise multiple cores, for example.

The processor 5 may run a Unix-based or Windows operating system, for example. The memory 7 may comprise solid state memory, e.g., one or more Solid State Disks (SSDs) made out of Flash memory, or one or more hard disks, for example.

The receiver 3 and the transmitter 4 may use one or more wired or wireless communication technologies to communicate with base stations 11 and 12. The receiver 3 and the transmitter 4 may use one or more communication technologies (wired or wireless) to communicate with other systems in the radio access network or in the core network, for example. The receiver 3 and the transmitter 4 may be combined in a transceiver. The system 1 may comprise other components typical for a component in a mobile communication network, e.g., a power supply.

In the embodiment shown in FIG. 9, the base stations 11 and 12 comprise one processor. In an alternative embodiment, one or more of the base stations 11 and 12 comprise multiple processors. The processor of the base stations 11 and 12 may be a general-purpose processor, e.g., an Intel or an AMD processor, or an application-specific processor, for example. The processor may comprise multiple cores, for example. The processor may run a Unix-based or Windows operating system, for example. The memory 27 may comprise solid state memory, e.g., one or more Solid State Disks (SSDs) made out of Flash memory, or one or more hard disks, for example.

The receiver 23 and the transmitter 24 may use one or more wireless communication technologies such as Wi-Fi, LTE, and/or 5G New Radio to communicate with UEs 31-36. The receiver 23 and the transmitter 24 may use one or more communication technologies (wired or wireless) to communicate with other systems in the radio access network or in the core network, for example. The receiver 23 and the transmitter 24 may be combined in a transceiver. The base stations may comprise other components typical for a component in a mobile communication network, e.g., a power supply. In the embodiment shown in FIG. 9, each of the base stations may comprise a single unit or a central unit and one or multiple distributed units, for example.

In the embodiment shown in FIG. 9, the UEs 31-32 and 34-35 comprise one processor 45. In an alternative embodiment, one or more of the UEs 31-32 and 34-35 comprise multiple processors. The processor 45 may be a general-purpose processor, e.g., an ARM or Qualcomm processor, or an application-specific processor. The processor 45 may run Google Android or Apple iOS as operating system, for example.

The receiver 43 and the transmitter 44 of the UEs 31-32 and 34-35 may use one or more wireless communication technologies such as Wi-Fi, LTE, and/or 5G New Radio to communicate with base stations, for example. The receiver 43 and the transmitter 44 may be combined in a transceiver. The UEs 31-32 and 34-35 may comprise other components typical for user equipment, e.g., a battery and/or a power connector.

A UE may also be referred to by those skilled in the art as a mobile station (MS), a subscriber station, a mobile unit, a subscriber unit, a wireless unit, a wireless terminal, a wireless device, a wireless communications device, a remote device, a mobile subscriber station, an access terminal (AT), a mobile terminal, a remote terminal, a handset, a terminal, a user agent, a mobile client, a client, or some other suitable terminology.

FIG. 10 is a block diagram of a second embodiment of a communication network comprising a system for enabling sensing of one or more objects and nodes for participating in the sensing of the one or more objects. FIG. 10 shows a cellular network which includes a (cloud/distributed-) Radio Access Network ((C/D-)RAN) 221 and a Core Network (CN) 211. The RAN 221 includes User Equipment (UEs) 223 and a Base Station (BS) 231. The CN 211 includes different CN-specific functions including the Communication Application Function (C-AF) 214 and the Sensing Application Function (S-AF) 213. The above-mentioned application functions (i.e. C-AF 214 and S-AF 213) take care of the corresponding applications. The BS 231 may comprise a plurality of distributed units that share a common centralized unit in a Centralized RAN (C-RAN) architecture, for example. FIG. 10 only shows one base station, in RAN 221 but RAN 221 would typically include multiple base stations.

The BS 231 is given the task of sensing upon getting a trigger for this sensing task from the S-AF 213. The BS 231 then performs the method shown in FIG. 1 by using different units/functions: information collector 235, node selector 238, radio resource manager 237, sensing data collector 234, and sensing data processor 233. In the embodiment of FIG. 10, the information collector 235, the sensing data processor 233, and the node selector 238 reside inside the BS 231. In an alternative embodiment, one or more of these units/functions are implemented outside of the BS 231, e.g. in a separate device.

The information collector 235 collects information from relevant entities in the network in the information collection phase (which includes steps 101-105 of FIG. 1).

The collected information may include the following information:
From S-AF 213: Sensing requirements, e.g. targeted area, targeted direction, targeted objects, sensing performance requirements, may be collected from the S-AF 213. In addition, sensing task priorities may also be specified, e.g. by the network operator in an operator policy.
From C-AF 214: Communication requirements, e.g., QoS requirements, type of service, are collected from the C-AF 214. In addition, communication task priorities may also be specified, e.g. by the network operator in an operator policy. These priorities should preferably be defined such that they have a correct relative meaning, e.g. sensing priority level 1 is to be treated as a higher priority level than communications priority level 2. These sensing task priorities and communication task priorities may be used to decide e.g. to what degree the excess communication performance (i.e. beyond the minimum requirement) is sacrificed in favor of sensing performance and vice versa.
From CM and PM information of BS 231: For example, information indicating the location of BS 231, cell-specific antenna settings, cell-specific carrier frequency, cell load, current set of actively transmitted reference signals, maximum transmit power, receiver characteristics, and average channel gain on the radio link between two nodes may be included in CM (Configuration Management) or PM (Performance Management) data. The CM and PM data may be stored and collected locally at the BS 231, e.g. in/from memory 236. Alternatively, the CM and PM data of BS 231 are not kept locally but at e.g. ‘Domain OAM Server’ or ‘Central OAM Server’.
From UEs 223: For example, information indicating UE locations, UE receiver characteristics, and frequency bands supported by the UEs may be collected. The information collector 235 may rely on already available UE information at the BS 231 that is collected for a different purpose. The information collection could be event-triggered (e.g. handover), or periodic. If required information is not available at the BS 231, the information collector 235 may transmit requests for new information (e.g. CSI) to all UEs or to a selected group of UEs. In the latter case, the UEs may be selected on UE locations, for example. For instance, UEs (both active and idle) located in the target sensing area may be selected. Idle UEs could e.g. be triggered by a broadcast message from BS 231 and possibly other BSs.
From CM and PM information of neighboring base stations (not shown in FIG. 10): For example, information indicating base station locations, cell-specific antenna settings, cell-specific carrier frequency, cell load, current set of actively transmitted reference signals, maximum transmit power, receiver characteristics, and average channel gain on the radio link between two nodes may be collected from the neighboring base stations. The neighboring base stations may be asked about active UEs currently served by them.
From a network planning tool (not shown in FIG. 10): In order to estimate the coverage overlap of a given cell and the target sensing area, the information collector 235 may be configured to get information from a network planning tool, which can estimate such overlap.

The information on each of the collection of nodes obtained in step 105 of FIG. 1 may be obtained from local information 236, from UEs 223, and/or from neighboring base stations, for example. This information may also be aggregated on domain level and/or central level, for example. The information on each of the collection of nodes may indicate, for example, one or more of: node location, cell-specific antenna settings, cell-specific carrier frequency, cell load, current set of actively transmitted reference signals, maximum transmit power, receiver characteristics, supported frequency bands, and average channel gain on the radio link between two nodes.

There are two main options for collecting information on sensing requirements from the S-AF 213 if the information collector 235 is part of the BS 231, which are:
1. Information is pushed by the S-AF 213 to the BS 231 via the information collector 235, e.g., for a specific sensing task the S-AF 213 forwards the requirements to a pre-assigned BS, e.g. BS 231, to carry out the sensing. If there is an update in the requirements of on-going sensing task, the update can be pushed to the assigned BS, e.g. BS 231. This is the preferred option;
2. Information is pulled from the S-AF 213 by the information collector 235, e.g., BS 231 may proactively/regularly check the updates in requirements.

Sensing measurements collected by the sensing data collector 234 may be shared with S-AF 213 (optionally via the information collector 235) as follows:
1. Sensing data collector 234 shares raw data, e.g., if BS 231 is a simple base station which has insufficient processing capability (e.g. in absence of a dedicated sensing data processor 233 in an embodiment different than the embodiment of FIG. 10) or when raw data of multiple base stations need to be fused/combined or otherwise jointly processed. In this implementation, the BS 231 enables the S-AF 213 to determine the one or more physical properties of the one or more sensed objects. In this implementation, the S-AF 213 is a data processing system which determines the one or more physical properties of each of the one or more objects based on the characteristics of the received signals obtained by the BS 231. For example, sensing data processor 233 may be included in S-AF 213 instead of in BS 231;
2. Sensing data processor 233 shares (semi-)processed data, e.g., if the BS 231 has sufficient processing capability (e.g. when there is a dedicated sensing data processor 233 as shown in FIG. 10) or in the case of limited backhaul capacity. In this implementation, the processor 233 of BS 231 determines the one or more physical properties of each of the one or more objects based on the characteristics of the received signals.

The interface between the C-AF 214 and the BS 231 may be 3GPP compliant (e.g. LTE, 5G). Considering 5G technology, assuming a Protocol Data Unit (PDU) session is already active, a device-terminating (in other words: network-originating) QoS flow establishment has the following steps: (i) the C-AF 214 first submits the flow establishment request to the Policy Control Function (PCF) 215; the PCF 215 acts as the coordinator in the flow establishment and (ii) checks via the Session Management Function (SMF) 216 with the BS 231 for admissibility from a RAN perspective and with the User Plane Function (UPF) 217 for admissibility from a core network perspective. As part of the process, the BS 231 will page the targeted UE, e.g. one of UEs 223, to establish a signaling connection, aiding in the admissibility check. In the case of a device-originating QoS flow establishment, the UE first establishes a signaling connection and then signals its QoS flow establishment request to the PCF 215, which again coordinates the process in the same way as done for the case of establishing a device-terminating QoS flow.

Based on the collected information, the node selector 238 performs steps 107 and 109 of the method of FIG. 1. One of the selected nodes may be the BS 231 itself. In this case, the node selector 238 instructs another component of the BS 231. Optionally, radio resource manager 237 then performs step 111 of the method of FIG. 1 by taking scheduling and beam management decisions. These decisions are used by the BS 231 to perform step 113 of FIG. 1. Next, the sensing data collector 234 performs step 115 of FIG. 1 and the sensing data processor 233 then performs step 117 of FIG. 1.

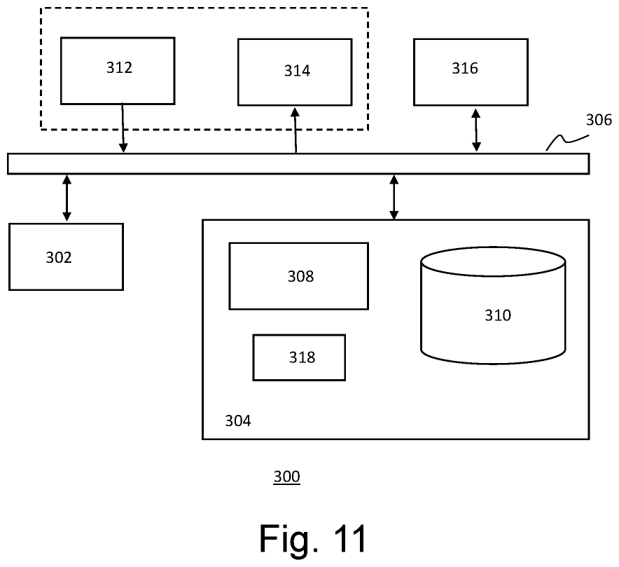

FIG. 11 depicts a block diagram illustrating an exemplary data processing system that may perform the method as described with reference to FIGS. 1-4 and 6.

As shown in FIG. 11, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 11 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 11, the memory elements 304 may store an application 318. In various embodiments, the application 318 may be stored in the local memory 308, he one or more bulk storage devices 310, or separate from the local memory and the bulk storage devices. It should be appreciated that the data processing system 300 may further execute an operating system (not shown in FIG. 11) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for enabling sensing of one or more objects, the system including at least one processor configured to:
obtain sensing requirements for sensing the one or more objects,
obtain communication requirements,
obtain information on each of a collection of nodes,
select a set of nodes from the collection of nodes based on the sensing requirements, the communication requirements, and the information on each of the collection of nodes, and
instruct one or more nodes of the set of nodes to participate in sensing the one or more objects, at least one node of the set of nodes transmitting wireless signals and at least one node of the set of nodes receiving the wireless signals.

2. A system as claimed in claim 1, wherein the at least one processor is configured to:
obtain characteristics of the received wireless signals, the received wireless signals comprising received versions of the transmitted wireless signals, the received wireless signals reflecting an impact of the one or more objects on the transmitted wireless signals, and
determine, or enable another system to determine, one or more physical properties of each of the one or more objects based on the characteristics of the received wireless signals.

3. A system as claimed in claim 1, wherein the information on each of the collection of nodes indicates one or more of: node location, cell-specific antenna settings, cell-specific carrier frequency, cell load, current set of actively transmitted reference signals, maximum transmit power, receiver characteristics, supported frequency bands, and average channel gain on the radio link between two nodes.

4. A system as claimed in claim 1, wherein the at least one processor is configured to assign each respective node of the set of nodes to a first set of transmitting nodes and/or a second set of receiving nodes, the first set of transmitting nodes transmitting the wireless signals and the second set of receiving nodes receiving the wireless signals.

5. A system as claimed in claim 4, wherein the at least one processor is configured to instruct the second set of receiving nodes to receive the wireless signals for the sole or additional purpose of sensing the one or more objects.

6. A system as claimed in claim 4, wherein the at least one processor is configured to instruct the first set of transmitting nodes to transmit the wireless signals for the sole or additional purpose of sensing the one or more objects-(9).

7. A system as claimed in claim 6, wherein the wireless signals include a wireless communication signal adjusted for the purpose of sensing the one or more objects and/or a dedicated sensing signal.

8. A system as claimed in claim 4, wherein the at least one processor is configured to:
form a plurality of candidate node combinations from the collection of nodes, each of the plurality of node combinations comprising a first subset and a second subset of the collection of nodes, the first subset being assigned the role of transmitting the wireless signals and the second subset being assigned the role of receiving the wireless signals,
determine, for each of the plurality of node combinations, based on the information on each of the collection of nodes, at least one communication performance for at least one communication task and at least one sensing performance for at least one sensing task,
determine for each of the plurality of node combinations, based on the at least one communication performance and the at least one sensing performance, whether the communication requirements and sensing requirements can be met,
select a node combination of the plurality of node combinations as the set of nodes based on one or more of the at least one communication performance and the at least one sensing performance and based on whether the communication requirements and sensing requirements can be met, and
assign the first subset of the selected node combination to the first set and the second subset of the selected node combination to the second set.

9. A system as claimed in claim 8, wherein the at least one processor is configured to determine the sensing performances by determining, for each node combination of the plurality of node combinations, for each sensing task of the at least one sensing task, a probability of detection based on the roles assigned to the nodes in the node combinations.

10. A system as claimed in claim 8, wherein the at least one processor is configured to:
determine, for each respective node combination of the plurality of node combinations, a processing cost at the second subset of the respective node combination based on the information on each of the collection of nodes, and
select the node combination as the set of nodes further based on the processing costs.

11. A system as claimed in claim 1, wherein the at least one processor is configured to:
select a plurality of candidate nodes from the collection of nodes based on the information on each of the collection of nodes, and
select the set of nodes from the plurality of candidate nodes based on the sensing requirements, the communication requirements, and the information.

12. A system as claimed in claim 11, wherein the information on each of the collection of nodes indicates a willingness and/or capability of a respective node to participate in the sensing of the one or more objects and/or indicates a proximity of a respective node to a target area, the target area being specified in the sensing requirements, and the at least one processor is configured to select the plurality of candidate nodes based on the willingness and/or the capability of the nodes to participate in the sensing and/or based on the proximity of the nodes to the target area.

13. A node for participating in sensing of one or more objects, the node including at least one processor configured to:
receive, from a system for enabling sensing of one or more objects, an instruction to participate in sensing the one or more objects, and
based on the instruction, transmit and/or receive wireless signals for the purpose of sensing the one or more objects, the received wireless signals comprising received versions of the transmitted wireless signals, the received wireless signals reflecting an impact of the one or more objects on the transmitted wireless signals.

14. A node as claimed in claim 13, wherein the instruction specifies whether the node should transmit, receive, or transmit and receive the wireless signals for the purpose of sensing the one or more objects and the at least one processor is configured to transmit, receive, or transmit and receive the wireless signals in dependence on the instruction.

15. A method of enabling sensing of one or more objects, the method including:
obtaining sensing requirements for sensing the one or more objects;
obtaining communication requirements;
obtaining information on each of a collection of nodes;
selecting a set of nodes from the collection of nodes based on the sensing requirements, the communication requirements, and the information on each of the collection of nodes; and
instructing one or more nodes of the set of nodes to participate in sensing the one or more objects, at least one node of the set of nodes transmitting wireless signals and at least one node of the set of nodes receiving the wireless signals.

16. A method of participating in sensing of one or more objects, the method including:
receiving, from a system for enabling sensing of one or more objects, an instruction to participate in sensing the one or more objects, and
based on the instruction, transmitting and/or receiving wireless signals for the purpose of sensing the one or more objects, the received wireless signals comprising received versions of the transmitted wireless signals, the received wireless signals reflecting an impact of the one or more objects on the transmitted wireless signals.

17. A computer program or suite of computer programs comprising at least one software code portion or a computer program product storing at least one software code portion, the software code portion, when run on a computer system, being configured for performing the method of claim 15.
